(19) United States
(12) Patent Application Publication
(10) Pub. No.: US 2024/0078330 A1
(43) Pub. Date: Mar. 7, 2024

(54) A METHOD AND SYSTEM FOR LOSSY COMPRESSION OF LOG FILES OF DATA

(71) Applicant: Red Bend Ltd., Hod Hasharon (IL)

(72) Inventors: Nir MORGULIS, Petah Tikva (IL); Shachar MENDELOWITZ, Hertzeliya (IL)

(21) Appl. No.: 18/262,887

(22) PCT Filed: Jan. 25, 2021
(86) PCT No.: PCT/IL2021/050077

§ 371 Date: Jul. 25, 2023

(51) Int. Cl. G06F 21/62; G06F 21/54; H03M 7/30

(52) U.S. Cl. CPC G06F 21/6218; G06F 21/54; H03M 7/3059

(57) ABSTRACT

A method and apparatus for log files of data compression are disclosed. The method comprising: classifying each of a plurality of lines in a plurality of the log files of data with at least two levels hierarchy clustering comprising identifying a plurality of strings repeated in the plurality of lines of the plurality of log files of data. Creating a table matching each of the plurality of strings to a unique value. Creating a vector encoding the unique value matched to each of the plurality of strings using the table. Assigning each of the encoded unique values in the vector, a security relevance score according to the classification of the plurality of lines; and selecting a subset of the encoded unique values such that the encoded unique values in the vector are filtered according to the security relevance score of each unique value.

### TECHNICAL FIELD

The present disclosure, in some embodiments thereof, relates to log files compression and, more specifically, but not exclusively, to lossy compression of log files of data.

### BACKGROUND

Data compression is a process of encoding information using fewer bits than the original representation. There are two types of compressions. The first is a lossless compression, which reduces information representation by identifying and eliminating statistical redundancy. In the lossless compression, no information is lost. The second, however, is a lossy compression. In a lossy compression, information is reduced by removing unnecessary information or less important information. The removed information is lost and usually cannot be reconstructed. Lossy compression is common for image files and voice and/or speech files, for example, Joint Photographic Experts Group (JPEG) and Moving Picture Experts Group Layer-3 Audio (MP3). However, for text files lossy compression is rarely used and all the known methods for text compression are lossless compression, for example, the ZIP method, Lempel Ziv Welch (LZ compression) and the like.

A device that performs data compression is typically referred to as an encoder, and a device that performs the reversal of the process, i.e. decompression, is referred to as a decoder.

Data compression may dramatically decrease the amount of storage a file takes up. For example, in a 2:1 compression ratio, a 20 megabyte (MB) file takes up 10 MB of space. As a result of compression, administrators spend less money and less time on storage.

Compression reduces storage hardware (optimizes backup storage performance), data transmission time and helps with data transmission on channels with limited bandwidth. As data continues to grow exponentially (e.g. the field of big data), compression plays a significant roll and becomes an important method of data reduction.

### SUMMARY

It is an object of the present disclosure to describe a system and a method for effectively compressing log files of data with a lossy compression, by creating a vector, which encodes unique values matched to lines in the log files of data.

It is another object of the present disclosure to describe a method for anomaly detection in log files of data by analyzing the created vector, which encodes the unique values matched to the lines in the log files of data.

The foregoing and other objects are achieved by the features of the independent claims. Further implementation forms are apparent from the dependent claims, the description and the figures.

In one aspect, the present disclosure relates to a method for log files of data compression. The method comprises: classifying each of a plurality of lines in a plurality of the log files of data with at least two levels hierarchy clustering comprising identifying a plurality of strings repeated in the plurality of lines of the plurality of log files of data; creating a table matching each of the plurality of strings to a unique value; creating a vector encoding the unique value matched to each of the plurality of strings using the table; assigning each of the encoded unique values in the vector, a security relevance score according to the classification of the plurality of lines; and selecting a subset of the encoded unique values such that the encoded unique values in the vector are filtered according to the security relevance score of each unique value.

The use of the at least two levels of hierarchy clustering, enables to use the same unique values to represent different strings when the strings belong to different clusters. This reduces the entropy of the compressed file when compared to standard compression algorithms such as Lempel-Ziv (LZ) compression.

The selection of the subset of the encoded unique values enables to filter less important strings in the log file. The filtration may be controlled, according to different needs of the implemented system and the size of the output compressed file may be determined accordingly.

In a further implementation of the first aspect, the method further comprises sending the vector to a detector for anomaly behavior detection in the plurality of the log files of data according to an analysis of the vector.

In a further implementation of the first aspect, the method further comprising a computer implemented method for generating a model for log files of data compression. The computer implemented method comprises: receiving a plurality of log files created by one or more electrical components; training at least one model with the plurality of log files to classify each of the plurality of lines in the plurality of log files and assigning each of the plurality of lines a security relevance score according to the classification of each of the plurality of lines; and outputting the at least one model for classifying each of the plurality of lines in the plurality of log files, and assigning each of the plurality of lines a security relevance score according to the classification of each of the plurality of lines, based on new log files created by other one or more electrical components.

In a further implementation of the first aspect, training at least one model further comprises extracting from each repeated string the string parameters and storing the string parameters in a separate file.

In a further implementation of the first aspect, the at least two levels hierarchy classifying is done according to:
a rough clustering based on the electrical component which created the log file of the log line; and
a fine clustering according to content similarity of the log line with other log lines.

The fine clustering may also be implemented as a hierarchical clustering, which reduced the entropy of the compressed file even more.

In a further implementation of the first aspect, the method further comprises compressing the selected subset of the unique values matched to the plurality of strings, with a binary compression algorithm.

In a further implementation of the first aspect, the method further comprises a computer implemented method for executing a model, for log files of data compression, comprising:
receiving a plurality of log files from one or more electrical components;
executing at least one model to classify each of a plurality of lines in the plurality of log files and assigning each of the plurality of lines a security relevance score according to the classification of each of the plurality of lines; and
classifying each of a plurality of lines in the plurality of log files and assigning each of the plurality of lines a security relevance score according to the classification of each of the plurality of lines, based on outputs of the execution of the at least one model.

In a further implementation of the first aspect, the analysis of the vector is done by a supervised machine learning algorithm that is trained with a labelled log lines of malicious and benign behaviour, to detect malicious behaviour in other log lines.

In a further implementation of the first aspect, the supervised machine learning algorithm is a member of the following list: decision tree, neural network, and support vector machines (SVM).

In a further implementation of the first aspect, the analysis of the created vector is done by an unsupervised machine learning algorithm that is trained with unlabeled log lines to detect anomaly behavior from normal behavior of other log lines.

In a further implementation of the first aspect, the unsupervised machine learning algorithm is a member of the following list: one class support vector machines (SVM) or auto-encoder.

In a further implementation of the first aspect, the log files of data are log files of vehicular data.

In a further implementation of the first aspect, the table is a hash table.

In a further implementation of the first aspect, the analysis of the vector is indicative of security threats.

In a second aspect, the present disclosure relates to a method for log files of data decompression. The method comprises: receiving an encoded file with a plurality of unique values, where each unique value represents a string from a plurality of strings; decoding the encoded file, according to a table matching each of the plurality of unique values to each of the strings from the plurality of strings; and combining each of the plurality of strings with parameters of each plurality of string, stored in a separate file, to reconstruct an original line of the encoded file before encoding.

In a third aspect, the present disclosure relates to an apparatus for logs compression, which comprises at least one processor configured to execute a code for:
classifying each of a plurality of lines in a plurality of the log files of data with at least two levels hierarchy clustering comprising identifying a plurality of strings repeated in the plurality of lines of the plurality of log files of data;
creating a table matching each of the plurality of strings to a unique value;
creating a vector encoding the unique value matched to each of the plurality of strings using the table;
assigning each of the encoded unique values in the vector, a security relevance score according to the classification of the plurality of lines; and
selecting a subset of the encoded unique values such that the encoded unique values in the vector are filtered according to the security relevance score of each unique value.

In a fourth aspect, the present disclosure relates to an apparatus for log files of data decompression, comprising at least one processor configured to execute a code for:
receiving an encoded file with a plurality of unique values, where each unique value represents a string from a plurality of strings;
decoding the encoded file, according to a table matching each of the plurality of unique values to each of the strings from the plurality of strings;
combining each of the plurality of strings with parameters of each plurality of string, stored in a separate file, to reconstruct an original line of the encoded file before encoding.

In a fifth aspect, the present disclosure relates to a computer program product provided on a non-transitory computer readable storage medium storing instructions for performing a method for log files of data compression, comprising:
classifying each of a plurality of lines in a plurality of the log files of data with at least two levels hierarchy clustering comprising identifying a plurality of strings repeated in the plurality of lines of the plurality of log files of data;
creating a table matching each of the plurality of strings to a unique value;
creating a vector encoding the unique value matched to each of the plurality of strings using the table;
assigning each of the encoded unique values in the vector, a security relevance score according to the classification of the plurality of lines; and
selecting a subset of the encoded unique values such that the encoded unique values in the vector are filtered according to the security relevance score of each unique value.

In a sixth aspect, the present disclosure relates to a computer program product provided on a non-transitory computer readable storage medium storing instructions for performing a method for log files of data decompression, comprising:
receiving an encoded file with a plurality of unique values, where each unique value represents a string from a plurality of strings;
decoding the encoded file, according to a table matching each of the plurality of unique values to each of the strings from the plurality of strings;
combining each of the plurality of strings with parameters of each plurality of string, stored in a separate file, to reconstruct an original line of the encoded file before encoding.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 schematically shows a block diagram of an apparatus for log files of data compression, according to some embodiments of the present disclosure;

FIG. 2 schematically shows a flow cart of a method for log files of data compression, according to some embodiments of the present disclosure;

FIG. 3 schematically shows a flow cart of a computer implemented method for generating a model for log files of data compression, according to some embodiments of the present disclosure;

FIG. 4 schematically shows an example of a Linux system log, which shows a rough clustering according to the device and/or component, which generated the log file of data, according to some embodiments of the present disclosure;

FIG. 5 schematically shows an example of a fine clustering, which is done according to log file content similarity, according to some embodiments of the present disclosure;

FIG. 6 schematically shows an example of a suffix array of a given string;

FIG. 7 schematically shows a flow chart of a computer implemented method for executing a model, for log files of data compression, according to some embodiments of the present disclosure;

FIG. 8 schematically shows an example of several hash tables that are received after the training phase, according to some embodiments of the present disclosure;

FIG. 9 schematically shows an example for the compressed file received after the compression of an original file, according to some embodiments of the present disclosure;

FIG. 10 schematically shows a graph of the compression performance as a function of the improvement factor over GZIP compression algorithm, according to some embodiments of the present disclosure;

FIG. 11 schematically shows an example of the creation of a vector of encoded unique values, according to some embodiments of the present disclosure;

FIG. 12 schematically shows an example of the flow of anomaly detection in a log file of data, according to some embodiments of the present disclosure; and

FIG. 13 schematically shows a flow chart of a method for log files of data decompression, according to some embodiments of the present disclosure.

### DETAILED DESCRIPTION

The present disclosure, in some embodiments thereof, relates to log files compression and, more specifically, but not exclusively, to lossy compression of log files of data.

The amount of data generated by different types of devices, components and machines is growing every day, and the data can be used for a large variety of applications in many fields.

However, the challenge of transmitting the increasing size of data from the different devices and machines to a central server limits the option to use the created and aggregated data in the different devices. For example, in the world of autonomic vehicles, every device might generate a large amount of data, typically in the form of log files of data with textual information, which may be very useful for investigating cases of security vulnerabilities. However, when the bandwidth of the transmitting channel from the devices to the central server is limited (sometime to a few kilobytes) the generated data is not transmitted due to the limited bandwidth (or limited amount of data, which is acceptable every day).

One way of dealing with this challenge is by compression of the data, which decreases the size of data transmitted. However, for textual information usually lossless compression is used, and the lossless compression is limited with the size to which the file may be compressed.

There is therefore a need to provide a way for increasing the efficiency of the compression of data and providing a method and apparatus which enables to compress the files of data to a size, which is controlled and may be determined according the needs of the system using the data files.

The present disclosure discloses a method and apparatus for an efficient log files of data compression, where the size of the compressed file is controlled and may be determined according to the needs of the system using the log files of data.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer and/or computerized device, partly on the user's computer and/or computerized device, as a stand-alone software package, partly on the user's computer (and/or computerized device) and partly on a remote computer or entirely on the remote computer or server. In the latter scenario, the remote computer may be connected to the user's computer and/or computerized device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

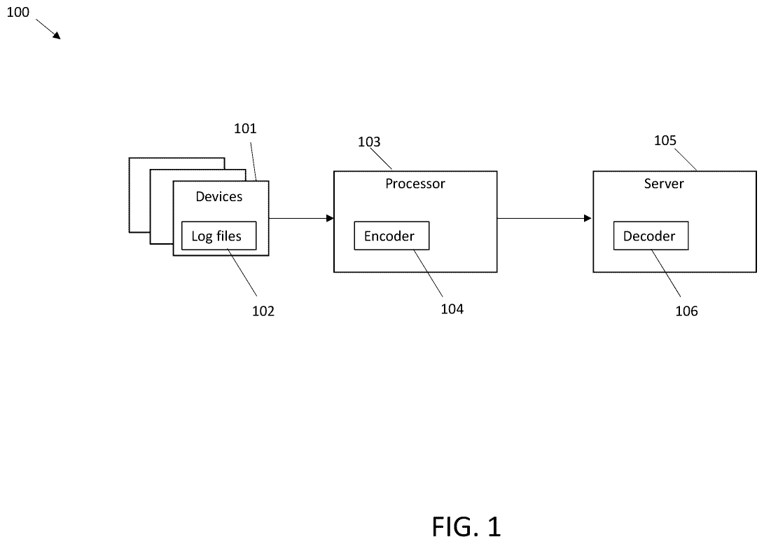

Reference is now made to FIG. 1, which schematically shows a block diagram of an apparatus 100 for log files of data compression, according to some embodiments of the present disclosure. The apparatus includes devices 101, where each of the devices contains a log file of data 102, a processor 103 with an encoder 104 and a server 105 with a decoder 106. The devices 101, may be any type of electrical component which is a part of a system and/or a network of devices connected between them. For example, electrical components in a car system such as the engine, ESP, safety system and the like. It may also be a more comprehensive system, for example a vehicle fleet monitoring system, where each vehicle in the fleet is represented as a device or a component. In these cases, the log files of data are log files of vehicular data. Each device 101 generates information in the form of a log file of data 102, which contains data about the device and the devices operation, typically as a text file with textual information. Processor 103 receives the log files of data 102 from all the devices 101 and executes a code, which classifies each of a plurality of lines in each log file of data, with at least two levels hierarchy clustering. The first level is a rough clustering. For example, based on the device and/or component, which generated the log file, i.e. group together the entire log files, which were generated by the same and/or component. The second level is a fine clustering. For example, identifying a plurality of strings repeated in the plurality of lines of the log files of data, based on common words, phrases and the like and storing in a separate file parameters related to each string repeated in the plurality of lines of the log files of data. The code executed by processor 103 further extracts format strings based on the repetitive patterns and creates a table, which matches each of the plurality of strings to a unique value. According to some embodiments of the present disclosure, the table may be any type of mapper, for example, a hash table, an additional labeling and the like. The match is stored for a future compression and/or decompression at encoder 104 and at decoder 106. In some embodiments of the present disclosure, encoder 104, creates a vector, which encodes the unique value matched to each of the plurality of strings using the table. Processor 103 assigns each of the encoded unique values in the vector, a security relevance score according to the classification of the plurality of lines. Once the security relevance score is assigned, the processor 103 executes a code, which selects a subset of the encoded unique values, such that the encoded unique value in the vector are filtered according to the security relevance score of each unique value. For example, the processor 103 selects a subset of the encoded unique values, which are above a predefined threshold. Alternatively, the processor 103 selects the subset of the encoded unique values according to a target size of data that may be transmitted from processor 103 to a server 105, due to bandwidth limitations. Server 105 receives the encoded selected subset, and decoder 106 decodes the subset according to the stored match table, which matches a unique value to each string from the plurality of strings. As a result, a set of strings is received. The server 105 combines each string in the received set of string with parameters of each string, which are stored in a separate file, to reconstruct an original line of the encoded file before it was encoded.

According to some embodiments of the present disclosure, in addition to the compression described above, the encoder sends the vector of unique values to a detector for anomaly behavior detection in the plurality of the log files of data, according to an analysis of the vector.

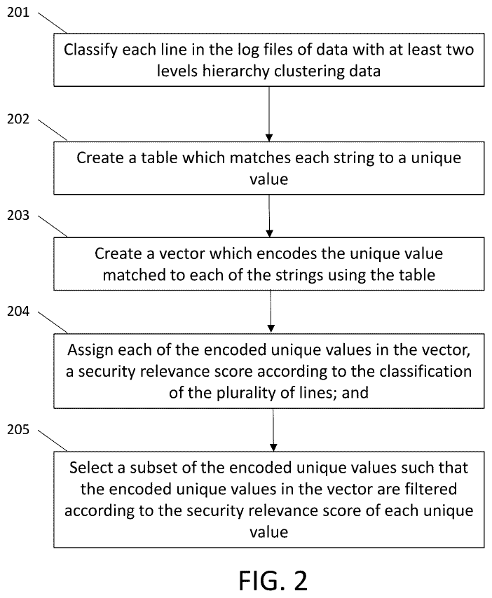

Reference is now made to FIG. 2, which schematically shows a flow cart of a method for log files of data compression, according to some embodiments of the present disclosure.

At 201, a plurality of log files of data are received from devices 101, at processor 103, which executes a code that according to some embodiments of the present disclosure, classifies each of the lines in the plurality of log files of data with at least two levels of hierarchy clustering. The first level of clustering is a rough clustering, and the second level is a fine clustering. For example, the first level of clustering may be based on context similarity, such as log files, which were generated by the same device and/or component. The second level of clustering may be based on content similarity, such as identifying repetitive strings in the lines of the log files (e.g. common words, phrases and the like). At 202, a table, which matches each string in the lines to a unique value is created by encoder 104. The unique value is a symbol, which represents a string. An efficient encoding uses the shortest symbol for representing the string, which is repeated the most, and the longest symbol for representing the string, which is repeated the fewest times. According to some embodiments of the present disclosure, the classification of at least two levels of hierarchy enables to improve the encoding of the strings in the lines of the plurality of log files of data, by using the same symbols at every level of the hierarchy, thereby, using the short symbols for representing strings, which are repeated many times. According to some embodiments of the present disclosure, the classification may be three levels hierarchy or more, where in every level the same symbols of the unique values are used again. At 203, a vector is created by encoder 104. The vector encodes the unique values matched to each of the plurality of strings using the table. At 204, each of the encoded unique values is assigned a security relevance score by the processor 103, according to the classification of the plurality of lines. At 205, a subset of the encoded unique values is selected by processor 103, such that the encoded unique values are filtered according to the security relevance score of each unique value. For example, the selected subset of encoded unique values may be the values with the highest security relevance score above a predefined threshold. In some other embodiments of the present disclosure the subset of encoded unique values may be selected according to target size of data that may be transmitted from processor 103 to a server 105, due to bandwidth limitations. For example, in a case of a bandwidth limitation of 500 kilobytes (kb), the encoded unique values with the highest security score are selected until the selected subset reaches the size of 500 kb. This way, even when the bandwidth limitation changes the method of compression of the present disclosure can be adapted to the changes and is still relevant.

According to some embodiments of the present disclosure, the use of a vector, which encodes the unique values, enables to analyze the vector according to different aspects and to detect anomalies in the log files of data, indicative of different aspects of analysis. For example, the vector may be analyzed according to security aspects and then detect anomalies in the log files indicative of security threats. Alternatively, the vector may be analyzed according to other aspects and then detect anomalies indicative of these other aspects, such as malfunctioning, so that the vector is analyzed according to malfunctioning aspects and then detect anomalies indicative of the malfunctioning aspects in the log files.

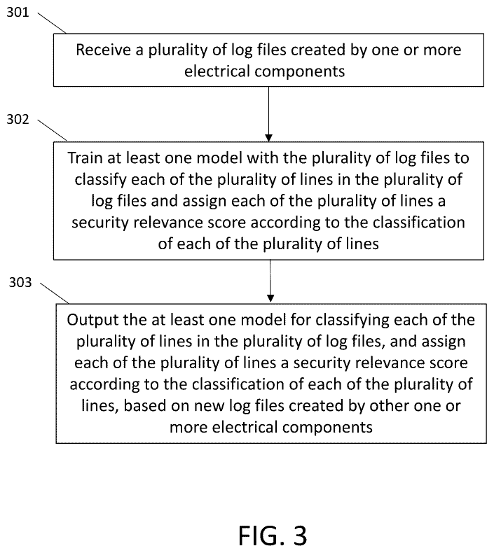

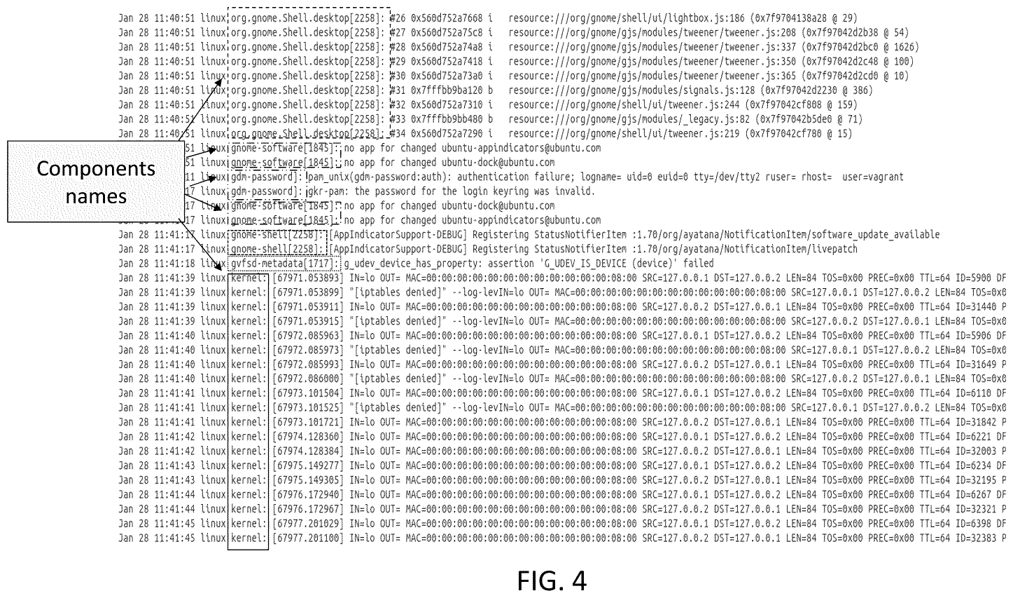

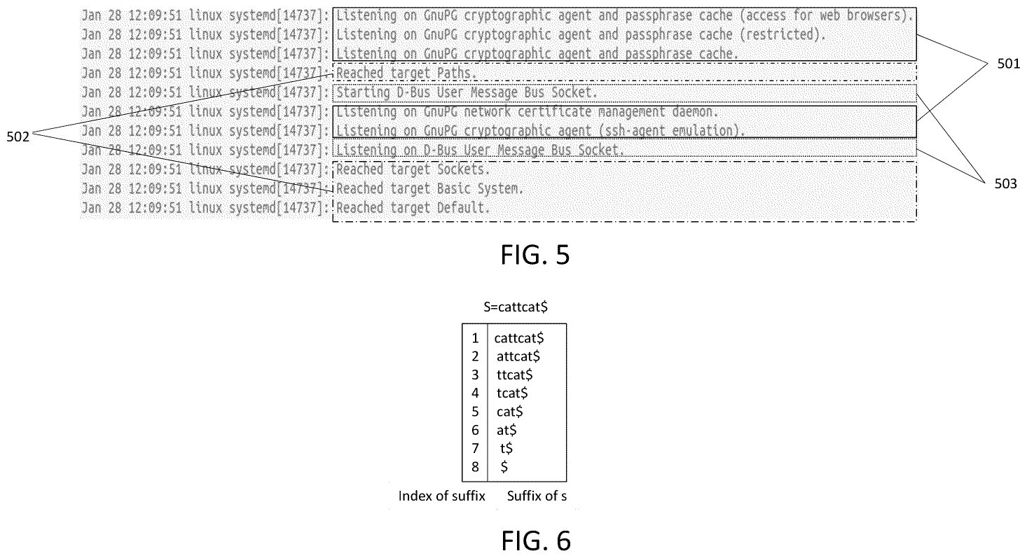

According to some embodiments of the present disclosure, the classification of the lines and strings in the log files may be done with a machine learning technique, with a model, which is trained to classify lines in the log files and assign a security relevance score to each of the lines according to the classification of each line. FIG. 3 schematically shows a computer implemented method for generating a model for log files of data compression, according to some embodiments of the present disclosure. At 301, processor 103 receives a plurality of log files created by one or more devices 101, which are electrical components. At 302, the processor 103 trains at least one model with the plurality of log files to classify each of the plurality of lines in the plurality of log files and assigns each of the plurality of lines a security relevance score according to the classification of each of the plurality of lines. At 303, processor 103 outputs the at least one model for classifying each of the plurality of lines in the plurality of log files. The outputted model assigns each of the plurality of lines a security relevance score according to the classification of each of the plurality of lines, based on new log files created by other one or more electrical components. According to some embodiments of the present disclosure, the classification of the lines and strings in the plurality of log files with at least two levels hierarchy is done in the training stage. First, a large corpus of log data files is required. Then, all lines in the log data files are separated in to groups, which is the at least two levels hierarchy classification. In the first level the groups are based on context similarity, for example, log lines, which were generated by the same device and/or component are grouped together. In the second level, the log lines groups are separated in to subgroups based on content similarity, for example, by identifying in the log lines common words, phrases and the like. The content similarity is performed in two phases. In the first phase the log lines are separated into subgroups based on different string similarity metrics. From each group of similar log lines, a single format string is extracted, according to repeating pattern counts. Then, each line is separated into two parts: first, the format string, which consists of all the repeating characters, which are common in every log line in the content group, and second, the parameters, which are the unique characters that appear only in the current line. All the data collected during the training phase is stored in a separate file on both encoder 104 and decoder 106 for fast access during runtime, where the trained model is executed. The second phase of the content similarity is performed during the runtime phase, where each log line is evaluated and classified into one of the content groups encountered in the training phase. FIG. 4 schematically shows an example of a Linux system log, which shows a rough clustering according to the device and/or component, which generated the log file of data. In the Linux system log presented, each line starts with a time stamp of the date and hour the log was generated, and then the name of the device and/or component that generated the log file. As can be seen, the names of the device and/or component, which generated the first nine lines is: “org. gnome.shell.desktop[2258]:”. The second device and/or component name is: “gnome-software [1845]:”. The third device and/or component name is “gdm—password]:”. The fourth device and/or component name is “gnome-software [1845]:”, which is the same as the second device and/or component. The fifth device and/or component name is “gnome—shell [2258]:”. The sixth device and/or component name is “gvfsd—metadata [1717]” and the seventh device and/or component name is “kernel”. FIG. 5 schematically shows an example of a fine clustering, which is done according to log file content similarity. In this example, a few lines from a system in Linux syslog are presented. As can be seen, three fine clusters are identified: 501, 502 and 503. From each one of the clusters a format string is extracted, that has a placeholder for additional parameters denote as “#” and give it a token, which is a unique value. The first cluster 501 is “Listening on GnuPG cryptographic agent and passphrase cache #”, it contains five log lines and it is given the unique value 0. The parameters of this line may be “(access for web browsers).”, “(restricted).”, “.”, and the like. The second cluster 502 is “Reached target #”, it contains four log lines, it is given the unique value 1 and the parameters of the line may be “Paths.”, “Sockets.”, “Basic System.”, “Default.”, and the like. The third cluster 503 is “#D-Bus User Message Bus Socket”, it contains two lines, it is given the unique value 2, and the parameters of the line may be “Starting” and “Listening on”. The fine clustering is done automatically, by comparing two strings and giving the two strings a similarity score. For example by using “Token Sort Ratio” algorithm, which is quite similar to FuzzyWuzzy library in python with minor amendments. In the training phase, for each rough cluster (i.e. for each identified device and/or component, which generated a log file of data) a list of fine clusters is created according to the fine clusters of the log lines of the rough cluster. The following process is performed for each rough cluster: for each new line, it is checked if the fine cluster is existed in the fine clusters list (for other checked lines). In case the fine cluster exists, the similarity between the new line and the first line of the fine cluster is calculated. When the similarity score calculated is bigger than a predefined threshold, the new line is added to the fine cluster. In case no matching cluster is found, a new fine cluster is created and added to the fine clusters list, and the new line is added to the fine cluster lines list.

After a fine-cluster of log lines that have similar content is created, the repeating patterns are extracted out to create a format string. A random sample of lines is taken from the cluster and merged to a one big string. Then, algorithms such as a suffix array and longest common prefix algorithms are used to map all unique patterns in the string. The redundant patterns are filter out, by removing any pattern that is longer than the shortest line in the cluster, keeping only patterns that appear on every single line in the cluster and merging short patterns into longer patterns that contain them. The filtered patterns are sorted as a list of patterns by length order (from the longest to the shortest). FIG. 6 schematically shows an example of using the suffix array algorithm.

Now, a format string can be created from the log lines and the patterns, as follows: for each pattern in the sorted list of patterns and for each line in the log lines, it is checked whether the pattern appears in the line. When the pattern appears, it is replaced with a temporary unique value, and the index of the pattern is stored. Otherwise, when the pattern is not in the line, the pattern is dropped. It is enough that the pattern does not appear in a single line for the pattern to be dropped. When the pattern was not dropped, the pattern and its location in the line are stored. After going over all the patterns and lines, anything that is left in the lines, which could not be replaced with a pattern is considered as a parameter. The valid patterns (that were not dropped) and their indexes are used to create a format string.

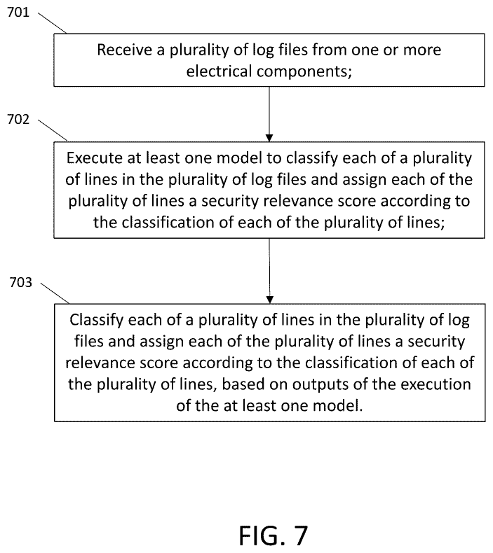

According to some embodiments of the present disclosure, after the training phase comes the runtime phase where the trained model is executed. The runtime phase is the actual process of compression, which is done by executing the trained model for log files of data compression, with new log files of data as an input. FIG. 7 schematically shows a flow chart of a computer implemented method for executing a model, for log files of data compression, according to some embodiments of the present disclosure. At 701, a plurality of log files are received from one or more devices and/or electrical components at processor 103. At 702, the at least one trained model is executed, to classify each of a plurality of lines in the plurality of log files and assign each of the plurality of lines a security relevance score according to the classification of each of the plurality of lines. At 703, each of a plurality of lines in the plurality of log files is classified and assigned a security relevance score according to the classification of each of the plurality of lines, based on outputs of the execution of the at least one model.

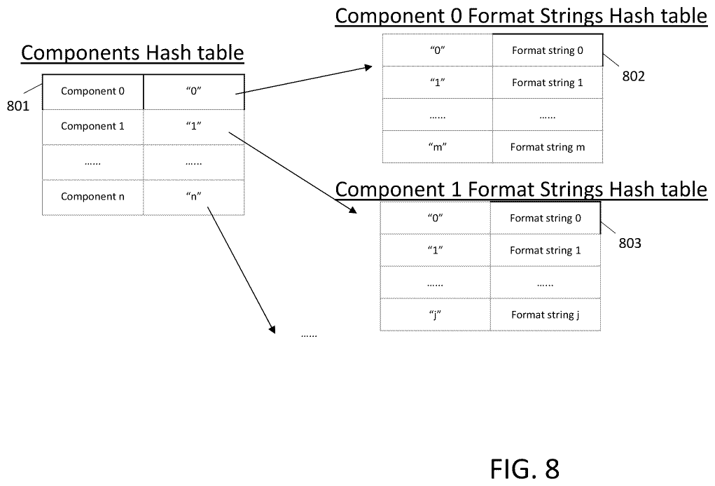

According to some embodiments of the present disclosure, after the training phase, several tables are received. FIG. 8 schematically shows an example of several hash tables that are received after the training phase, according to some embodiments of the present disclosure. The first hash table 801 is a hash table of components, which generated the log files. This hash tables represent the rough clustering. Each component is given a unique value. For example, and as can be seen from the hash table 801, component 0 is given the unique value “0”, component 1 is given the unique value “1”, and so on until component n is given the unique value “n”. The other hash tables are the hash tables for each component format string. These hash tables represent the fine clustering. For each component of hash table 801, a format string hash table is received, where a unique value is given to each string in the component. For example, as can be seen in FIG. 8 for component 0—which was given the unique value “0” a hash table 802 is received. In the hash table 802, every format string identified in the log files generated by component 0 is given a unique value. For example, format string 0 of component 0 is given the unique value “0”. Format string 1 of component 0 is given the unique value “1” and so on until format string m of component 0 is given the unique value “m”. The same is true also for the other hash tables of the other components. Hash table 803 is received for component 1, and shows the unique value each format string of component 1 is given. The unique values may be the same unique values used at hash table 801, which represents the rough clustering, as hash tables 802, 803 and the like represent a different level of clustering of the fine clustering. According to some embodiments of the present disclosure, additional levels of fine clustering may be implemented for better compression, by adding hash tables for each format string of each component and so on.

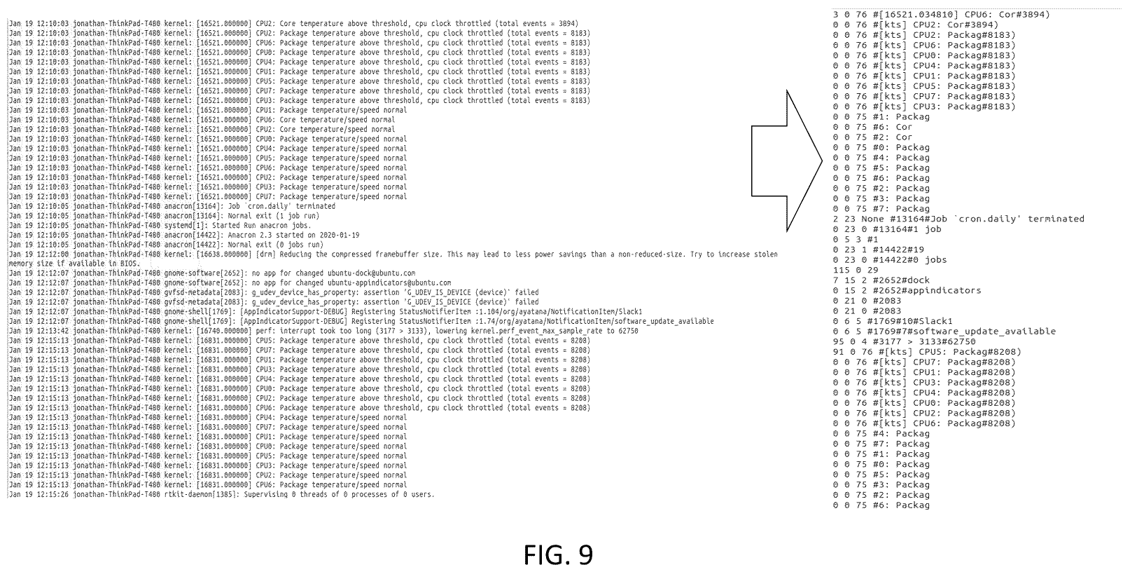

In the compression process, all the lines in each log file of data is iterated. Each line is broken into its components. A typical example of a system log line looks like this: “Jan 28 12:09:51 linux systemd[1]: Stopped User Manager for UID 2.” The first part, “Jan 28 12:09:51” is the date, which is replaced with an integer timestamp. For a further efficiency, only the timestamp of the first line may be kept. In the rest of lines the time diff from the previous line may be kept. The second part, “Linux” is the machine name. This part may be dropped from all the lines except for the first line of the log file, since it is always the same. The third part, “systemd[1]” is the component name. This part is replaced with its corresponding unique value from the components hash table. The fourth part, “Stopped User Manager for UID 2” is the log content line, which is compared to all templates in its component format string hash table. The one with the highest match score is used. The line is replaced by the format string unique value and the parameters of the line. After the compression process a compressed file is received, which is much smaller than the original file. Optionally, the received compressed file may be further compressed with a traditional binary lossless compression algorithm such as GZIP and the like. FIG. 9 schematically shows an example for the compressed file received after the compression of an original file, according to some embodiments of the present disclosure.

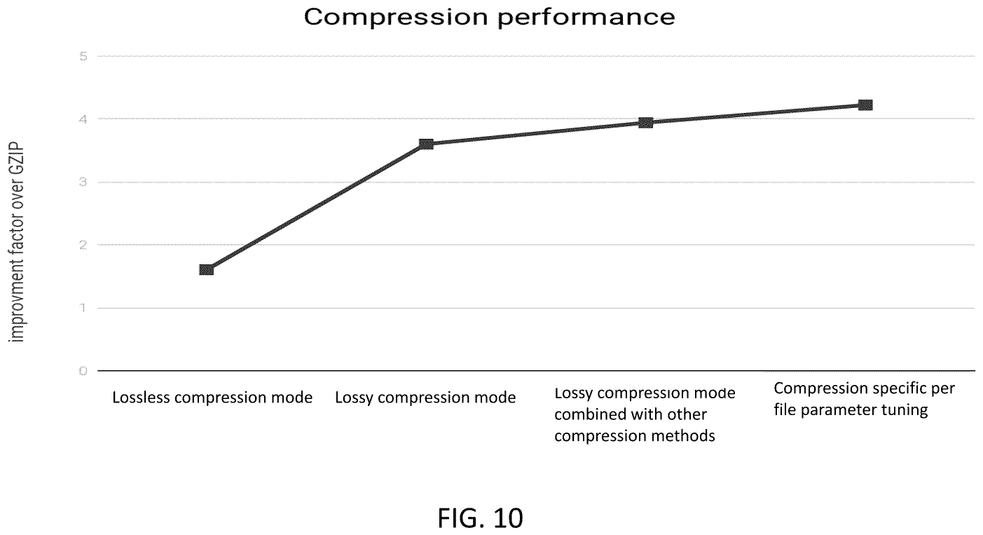

FIG. 10 schematically shows a graph of the compression performance as a function of the improvement factor over GZIP compression algorithm, according to some embodiment of the present disclosure. It can be seen from the graph that when the compression described in the present disclosure is in a lossless compression mode, the improvement is almost double in comparison to the GZIP compression algorithm. When the compression is in a lossy compression mode, the improvement raises to be almost 4 times better. When the compression disclosed in the present disclosure is in a lossy compression mode and combined with other compression algorithms, the improvement is even higher. When the compression is specific per file parameter tuning, the improvement raises even more.

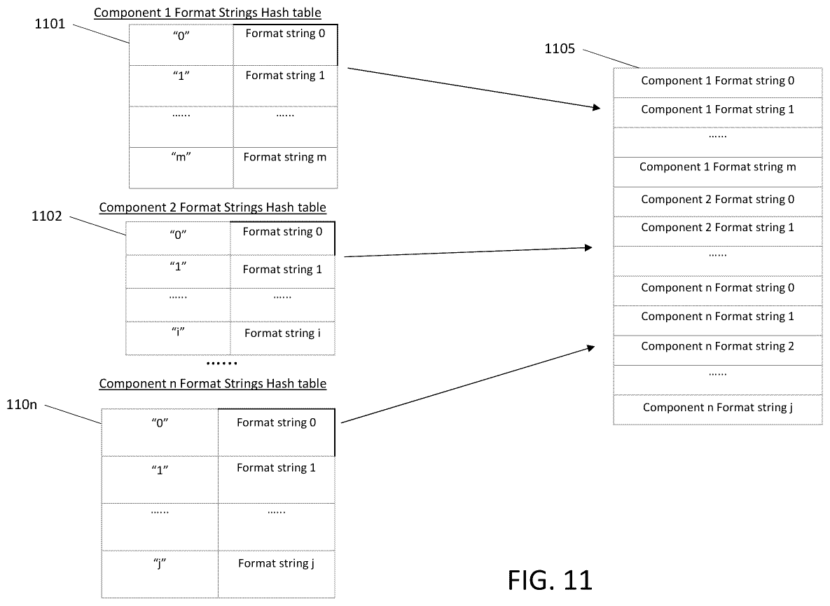

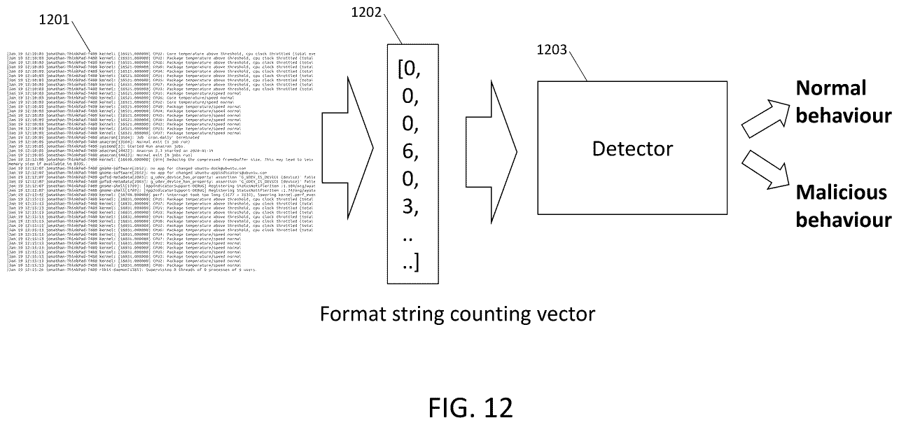

According to some embodiments of the present disclosure, an alternative representation of the clusters hash tables is to accumulate all indexes of all hash tables into one vector, where each format string is identified by a coordinate. This vector is the vector, which encodes the unique values given to each format string. FIG. 11 schematically shows an example of the creation of the vector of encoded unique values, according to some embodiments of the present disclosure. In this example hash tables re used. The hash tables of each format string component are embedded into one vector. Hash table 1101, hash table 1102 and so on until hash table 110n are embedded into vector 1105. In the vector, each format string of each component is represented with a coordinated, which is a unique value. For example, the format string 0 of component 1 is given the unique value “0”. The format string 1 of component 1 is given the unique value “1” and so on until format string m of component 1 is given the unique value “m”. The same is done for the other hash tables. The format string 0 of component 2 is given the unique value m+1 and the so on until the format string i is given the unique value m+i+1. The same is true for all the components until component n, where format string j of component n is given the unique value, m+i+ . . . +j+(n−1). Eventually a vector is received of the length m+i+ . . . +j+n. According to some embodiments of the present disclosure, the creation of the vectorise representation is very useful, as it allows to analyse the vector with vectors analysis algorithms, and infer different conclusion for a large scale of applications and in a variety of fields. For example, a further vector may be created, that counts the appearances of each format string, and this way easily infer about the importance of the string. Another example may be the use of the vector to analyse an entire file or just a certain time period within a log file of data. According to some embodiments of the present disclosure, the vector, which encodes the unique values of the format strings, may be sent into a detector for anomaly behavior detection in the plurality of the log files of data, to be analyzed. Then, based on the analysis of the vector, the detector detects anomalies in the plurality of the log files of data, when exist. The detector is a decision maker, which may be any kind of algorithm code executed by processor 103, which can analyse a vector input. In some embodiments of the present disclosure, the detector is a trained model that analyses the vector and can identify malicious behaviour from the appearance of certain log lines. The detector may be a supervised machine learning algorithm such as decision tree, neural network, support vector machines (SVM), and the like, that was trained with labelled dataset malicious and benign samples, and tries to identify the malicious cases. Alternatively, it may be an unsupervised model such as one-class-SVM or auto-encoder, which was trained on unlabelled data and tries to spot anomalies from the normal behaviour. Optionally, the detector (decision maker) may even be a person, although a person is less effective, in this case. FIG. 12 schematically shows an example of the flow of anomaly detection in a log file of data, according to some embodiments of the present disclosure. At 1201, a log file of data is received. At 1202, a vector, which was computed from the vector encoding the unique values, and which counts the appearance of each format string is created and at 1203, the vector is inputted into a detector to detect anomalies in the log file of data. In case an anomaly is detected, the detector, indicates the detection of a malicious behaviour, for example by a issuing a report or activating an electrical indicator. Otherwise, when no anomaly is detected the detector indicates on a normal behaviour.

Referring back to the vector encoding the unique values. According to some embodiments of the present disclosure, after the creation of the vector, which encodes the unique values, a relevance score is assigned to each encoded unique value in the vector, where each encoded unique value represents a string (or a line) in the log file of data. The relevance score may be assigned after the anomaly detection process, according to the effect that each line has on the outcome of the detector. Then, a lossy compression may be carried out, by filtering lines and parameters, which are not contributing important information. There are many standard feature-ranking techniques for assigning the relevance score, which are useful for this case, and which are well known in the art to persons skilled in the art and are therefore not described herein. Optionally, the maximal desired output size may be determined and lines may be filtered until reaching the determined size.

Reference is now made to a decompression apparatus and method of the compression method described herein, according to some embodiments of the present disclosure. The apparatus for decompression comprises at least one server with at least one processor, which receives an encoded file with a plurality of unique values, where each unique value represents a string from a plurality of strings. The processor includes a decoder, which decodes the encoded file according to a table matching each of the plurality of unique values to each of the strings from the plurality of strings. The at least one processor then, executes a code which combines each of the plurality of strings received after the decoding, with parameters of each plurality of string, stored in a separate file, to reconstruct an original line of the encoded file before encoding.

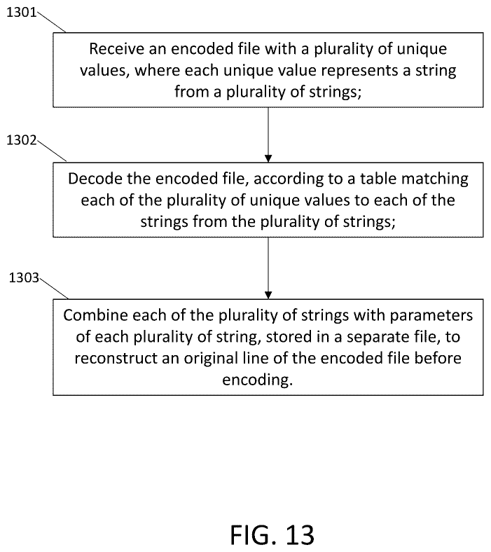

FIG. 13, schematically shows a flow chart of a method for log files of data decompression, according to some embodiments of the present disclosure. At 1301, an encoded file with a plurality of unique values is received by at least one processor of at least one server. Each unique value represents a string from a plurality of strings. At 1302, the encoded file is decoded by a decoder included in the at least one processor, according to a table matching each of the plurality of unique values to each of the strings from the plurality of strings. At 1303, each of the plurality of strings received after the decoding is combined with parameters of each plurality of string, stored in a separate file, to reconstruct an original line of the encoded file before encoding.

According to some embodiments of the present disclosure, a computer program product provided on a non-transitory computer readable storage medium storing instructions for performing the method for log files of data compression described in the present disclosure, is disclosed herein.

According to some embodiments of the present disclosure, a computer program product provided on a non-transitory computer readable storage medium storing instructions for performing the method for log files of data decompression described in the present disclosure, is disclosed herein.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems for lossy compression of log files of data will be developed and the scope of the term methods and systems for lossy compression of log files of data is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Throughout this application, various embodiments of this disclosure may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specific ally and individually indicated to be incorporated herein by reference. In addition, citation or identification of any reference in this application shall not be construed as an admission that such reference is available as prior art to the present disclosure. To the extent that section headings are used, they should not be construed as necessarily limiting. In addition, any priority document(s) of this application is/are hereby incorporated herein by reference in its/their entirety.

1. A method for log files of data compression, comprising:
classifying each of a plurality of lines in a plurality of the log files of data with at least two levels hierarchy clustering comprising identifying a plurality of strings repeated in the plurality of lines of the plurality of log files of data;
creating a table matching each of the plurality of strings to a unique value;
creating a vector encoding the unique value matched to each of the plurality of strings using the table;
assigning each of the encoded unique values in the vector, a security relevance score according to the classification of the plurality of lines; and
selecting a subset of the encoded unique values such that the encoded unique values in the vector are filtered according to the security relevance score of each unique value.

2. The method of claim 1, further comprising:
sending the vector to a detector for anomaly behavior detection in the plurality of the log files of data according to an analysis of the vector.

3. The method of claim 1, further comprising a computer implemented method for generating a model for log files of data compression, comprising:
receiving a plurality of log files created by one or more electrical components;
training at least one model with the plurality of log files to classify each of the plurality of lines in the plurality of log files and assigning each of the plurality of lines a security relevance score according to the classification of each of the plurality of lines;
outputting the at least one model for classifying each of the plurality of lines in the plurality of log files, and assigning each of the plurality of lines a security relevance score according to the classification of each of the plurality of lines, based on new log files created by other one or more electrical components.

4. The method of claim 3, wherein training at least one model further comprising:
extracting from each repeated string the string parameters and storing the string parameters in a separate file.

5. The method of claim 1, wherein the at least two levels hierarchy classifying is done according to:
a rough clustering based on the electrical component which created the log file of the log line; and
a fine clustering according to content similarity of the log line with other log lines.

6. The method of claim 1, further comprising: compressing the selected subset of the unique values matched to the plurality of strings, with a binary compression algorithm.

7. The method of claim 1, further comprising a computer implemented method for executing a model, for log files of data compression, comprising:
receiving a plurality of log files from one or more electrical components;
executing at least one model to classify each of a plurality of lines in the plurality of log files and assigning each of the plurality of lines a security relevance score according to the classification of each of the plurality of lines; and
classifying each of a plurality of lines in the plurality of log files and assigning each of the plurality of lines a security relevance score according to the classification of each of the plurality of lines, based on outputs of the execution of the at least one model.

8. The method of claim 2, wherein the analysis of the vector is done by a supervised machine learning algorithm that is trained with a labelled log lines of malicious and benign behaviour, to detect malicious behaviour in other log lines.

9. The method of claim 8, wherein the supervised machine learning algorithm is a member of the following list: decision tree, neural network, and support vector machines (SVM).

10. The method of claim 2, wherein the analysis of the created vector is done by an unsupervised machine learning algorithm that is trained with unlabeled log lines to detect anomaly behavior from normal behavior of other log lines.

11. The method of claim 10, wherein the unsupervised machine learning algorithm is a member of the following list: one class support vector machines (SVM) or auto-encoder.

12. The method of claim 1, wherein the log files of data are log files of vehicular data.

13. The method of claim 1, wherein the table is a hash table.

14. The method of claim 2, wherein the analysis of the vector is indicative of security threats.

15. A method for log files of data decompression, comprising:
receiving an encoded file with a plurality of unique values, where each unique value represents a string from a plurality of strings;
decoding the encoded file, according to a table matching each of the plurality of unique values to each of the strings from the plurality of strings;
combining each of the plurality of strings with parameters of each plurality of string, stored in a separate file, to reconstruct an original line of the encoded file before encoding.

16. An apparatus for logs compression, comprising at least one processor configured to execute a code for:
classifying each of a plurality of lines in a plurality of the log files of data with at least two levels hierarchy clustering comprising identifying a plurality of strings repeated in the plurality of lines of the plurality of log files of data;
creating a table matching each of the plurality of strings to a unique value;
creating a vector encoding the unique value matched to each of the plurality of strings using the table;
assigning each of the encoded unique values in the vector, a security relevance score according to the classification of the plurality of lines; and
selecting a subset of the encoded unique values such that the encoded unique values in the vector are filtered according to the security relevance score of each unique value.

17. (canceled)

18. (canceled)

19. (canceled)
